(19) United States
(12) Patent Application Publication
(10) Pub. No.: US 2009/0325011 A1
(43) Pub. Date: Dec. 31, 2009

(54) FUEL CELL

(76) Inventors: Tatsuyuki Nakagawa, Osaka (JP); Masato Nishikawa, Saitama (JP); Hitoshi Kihara, Osaka (JP)

Correspondence Address: MCDERMOTT WILL & EMERY LLP, 600 13TH STREET, N.W., WASHINGTON, DC, 20005-3096, US

(21) Appl. No.: 12/443,629

(22) PCT Filed: Sep. 27, 2007
(86) PCT No.: PCT/JP2007/068870

§ 371 Date: Jun. 22, 2009

(30) Foreign Application Priority Data
Sep. 29, 2006 (JP) 2006-270097
Sep. 10, 2007 (JP) 2007-234622

(51) Int. Cl. H01M 8/10; H01M 8/04

(52) U.S. Cl. 429/22; 429/30

(57) ABSTRACT

A fuel cell includes a membrane electrode assembly 1 in which an oxidant electrode and a fuel electrode are disposed on the respective sides of an electrolyte layer. The fuel cell includes a vibrating plate 32 which generates an acoustic wave, and which is disposed so as to face the oxidant electrode with a flow path 30 for a gas formed between the vibrating plate and the oxidant electrode. The vibrating plate 32 is formed to have at least one hole 34. Moreover, the gas is transferred by acoustic streaming that occurs in the flow path for the gas 30 due to vibration of the vibrating plate 32 and reflection on a surface of the oxidant electrode facing the vibrating plate 32.

### RELATED APPLICATIONS

This application is the U.S. National Phase under 35 U.S.C. § 371 of International Application No. PCT/JP2007/068870, filed on Sep. 27, 2007, which in turn claims the benefit of Japanese Application Nos. 2006-270097, filed Sep. 29, 2006 and 2007-234622, filed Sep. 10, 2007, the disclosures of which Applications are incorporated by reference herein.

### TECHNICAL FIELD

The present invention relates to a fuel cell including a membrane electrode assembly in which an oxidant electrode and a fuel electrode are disposed on the respective sides of an electrolyte layer.

### BACKGROUND ART

A fuel cell has a high energy conversion efficiency, and generates no harmful substance by its power-generating reaction. Accordingly, the fuel cell has attracted attention as an energy source for various electric appliances.

FIG. 1 shows a specific structure of a unit cell constituting a fuel cell. As shown in FIG. 1, an oxidant electrode 12 and a fuel electrode 13 are disposed on the respective sides of an electrolyte layer 11 to thus constitute a membrane electrode assembly (MEA) 1.

An oxidant-electrode-side conductive plate 14 provided with multiple concave-shaped air-supplying grooves 19 is disposed to cover the surface of the oxidant electrode 12 constituting the membrane electrode assembly 1. Furthermore, a gas separator 16 is disposed outside the oxidant-electrode-side conductive plate 14. Meanwhile, a fuel-electrode-side conductive plate 17 provided with multiple concave-shaped fuel-gas-supplying grooves 18 is disposed to cover the surface of the fuel electrode 13 constituting the membrane electrode assembly 1.

In the above-described fuel cell, air is fed into the air-supplying grooves 19 of the oxidant-electrode-side conductive plate 14, and fuel gas is fed into the fuel-gas-supplying grooves 18 of the fuel-electrode-side conductive plate 17 to thereby produce electricity.

In recent years, it has been considered to equip a fuel cell as a power source in a small electronic appliance. For example, a direct methanol fuel cell (DMFC) that can be made thin is most likely adopted as such a fuel cell. To produce electricity in the DMFC, oxidizing gas such as air and oxygen is supplied to the oxidant electrode 12, and a fuel, such as methanol, in a gas form or directly in a liquid form is supplied to the fuel electrode 13.

In order to equip with the fuel cell in a small electronic appliance, however, size reduction is required for gas-supplying units for supplying the air and fuel gas when these gases are supplied into the oxidant electrode 12 and the fuel electrode 13, respectively.

Conventionally, a unit which supplies gas by vibrating a fuel cell is disclosed as the small gas-supplying unit (see, for example, Patent Document 1 and Patent Document 2.). Patent Document 1 proposes a gas-injecting unit which injects gas using multiple chambers formed by a vibrating body. Patent Document 2 proposes a fuel cell including vibrating means for vibrating an oxidant electrode, a fuel electrode, a separator, and the like.

### Patent Document 1: JP-A 2005-243496

### Patent Document 2: JP-A 2002-203585

### DISCLOSURE OF THE INVENTION

On the oxidant electrode side in the fuel cell, oxygen thus supplied and hydrogen ions react with each other to form water. The conventional techniques have not established a route for removing this formed water, and have a problem that the formed water remains inside the fuel cell.

Therefore, in view of the above problems, an object of the present invention is to provide a fuel cell from which formed water is easily removed.

An aspect of the present invention is a fuel cell provided with a membrane electrode assembly in which an oxidant electrode and a fuel electrode are disposed respectively on sides of an electrolyte layer. The fuel cell includes a vibrating plate disposed so as to face the oxidant electrode with a flow path for a gas formed between the vibrating plate and the oxidant electrode, and configured to vibrate. The vibrating plate is formed to have at least one hole.

In the fuel cell according to the aspect of the present invention, as water evaporates through the hole formed in the vibrating plate, formed water can be removed easily.

Moreover, in the fuel cell according to the aspect of the present invention, it is preferable that the vibrating plate have a hydrophilic surface on the oxidant electrode side, and that the oxidant electrode have a water-repellent surface on the vibrating plate side.

This fuel cell makes formed water easily move from the oxidant electrode side to the vibrating plate side, and also the vibration energy is more easily transferred to the water droplets. In this manner, the formed water is removed more efficiently.

Moreover, in the fuel cell according to the aspect of the present invention, the vibrating plate preferably has a shape in which comb-shaped portions face each other with the hole formed between the comb-shaped portions.

This fuel cell increases the amplitude at a portion that corresponds to a loop of the vibration, and increases the vibration energy. In this manner, a larger amount of formed water is removed.

Moreover, in the fuel cell according to the aspect of the present invention, the gas may be transferred by acoustic streaming that occurs in the flow path for the gas due to the vibration of the vibrating plate and reflection on the surface of the oxidant electrode facing the vibrating plate.

In this fuel cell, the acoustic streaming efficiently feeds oxygen to the oxidant electrode.

Moreover, in the fuel cell according to the aspect of the present invention, the hole in the vibrating plate is preferably shaped symmetrically with respect to a central line of the vibrating plate.

In this fuel cell, the symmetry with respect to the central line makes uniform vibration possible.

Moreover, in the fuel cell according to the aspect of the present invention, the vibrating plate may have a plurality of holes, and have a shape in which comb-shaped portions face and interdigitate with each other with each of the plurality of holes formed between the comb-shaped portions, and length of respective tooth provided on each of the comb-shaped portions may increase stepwise from one side of the vibrating plate toward the other side.

This fuel cell forms a sound pressure gradient in the gas flow path.

Furthermore, the fuel cell according to the aspect of the present invention may further comprise: a circuit configured to control the vibration of the vibrating plate and to provide a resonant frequency of the vibrating plate.

According to this fuel cell, even when water droplets are attached to the vibrating plate and cause the resonant frequency to change, the resonant frequency corresponding to that state can be provided.

### BRIEF DESCRIPTION OF THE DRAWINGS

FIG. 1 is an exploded perspective view of a conventional fuel cell.

FIG. 2 is an exploded perspective view of a fuel cell according to a first embodiment.

FIG. 3 is a cross-sectional view of the fuel cell according to the first embodiment.

FIG. 4 is a perspective view of a vibrating plate according to the first embodiment.

FIG. 5 is a top view of another vibrating plate according to the first embodiment.

FIG. 6 is a drawing for explaining the surface characteristics of the vibrating plate and an oxidant electrode according to the first embodiment.

FIG. 7 is a drawing for explaining the frequency change by a piezoelectric element according to the first embodiment (No. 1).

FIG. 8 is a drawing for explaining the frequency change by the piezoelectric element according to the first embodiment (No. 2).

FIG. 9 is another cross-sectional view of the fuel cell according to the first embodiment.

FIG. 10 is a functional block diagram of a fuel cell system according to the first embodiment.

FIG. 11 is a flowchart for illustrating a controlling method of the fuel cell according to the first embodiment.

FIG. 12 is a drawing for explaining the frequency change by the piezoelectric element according to the first embodiment (No. 3).

FIG. 13 is a drawing for explaining effects and advantages of the fuel cell according to the first embodiment.

FIG. 14 is a drawing for explaining the principle of how acoustic streaming occurs in a second embodiment.

FIG. 15 is a top view of another vibrating plate according to the second embodiment.

FIG. 16 is a cross-sectional view of a fuel cell according to a third embodiment.

FIG. 17 is a cross-sectional view for explaining that a vibrating plate resonates in a gas-transferring direction in the fuel cell according to the third embodiment.

FIG. 18 is a perspective view of a fuel cell according to a fourth embodiment.

FIG. 19 is a cross-sectional view of the fuel cell according to the fourth embodiment.

FIG. 20 is a perspective view of a fuel cell according to a fifth embodiment.

FIG. 21 is a cross-sectional view of the fuel cell according the fifth embodiment.

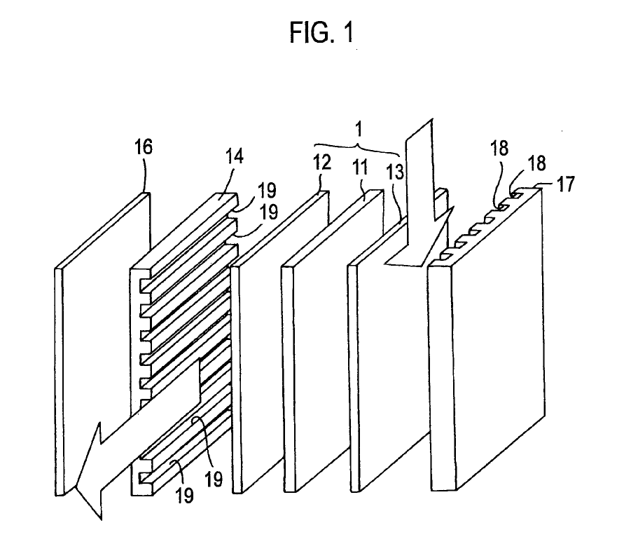

### BEST MODES FOR CARRYING OUT THE INVENTION

Hereinafter, embodiments of the present invention will be described with reference to the drawings. In the following description on the drawings, identical or similar components are denoted by identical or similar reference symbols. It should be noted, however, that the drawings are schematic, and that the dimensional proportions and the like are different from their actual values. Accordingly, specific dimensions and the like should be inferred on the basis of the description given below. Moreover, it goes without saying that dimensional relationships and dimensional proportions may be different from one drawing to another in some parts.

### First Embodiment

(Fuel Cell)

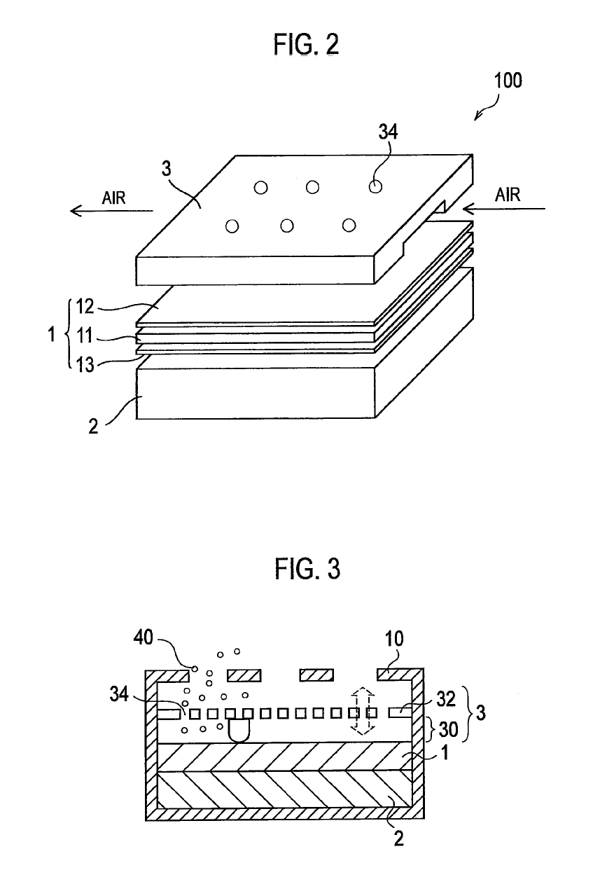

As shown in FIG. 2, a fuel cell 100 according to a first embodiment includes: a membrane electrode assembly 1, a fuel-supplying mechanism 2 and an air-supplying mechanism 3. The membrane electrode assembly 1 includes an oxidant electrode 12 and a fuel electrode 13 disposed on the respective sides of an electrolyte layer 11. The fuel-supplying mechanism 2 is disposed to cover the surface of the fuel electrode 13. The air-supplying mechanism 3 is disposed to cover the surface of the oxidant electrode 12. Here, the electrolyte layer 11 may be an electrolyte membrane such as a solid polymer membrane.

Moreover, a hole 34 for taking air therein is formed in the air-supplying mechanism 3. The hole 34 also functions to discharge formed water to the outside. In FIG. 2, the holes 34 are formed in the upper portion and side portion of the air-supplying mechanism 3. Here, the shape of the hole 34 may be circular or rectangular.

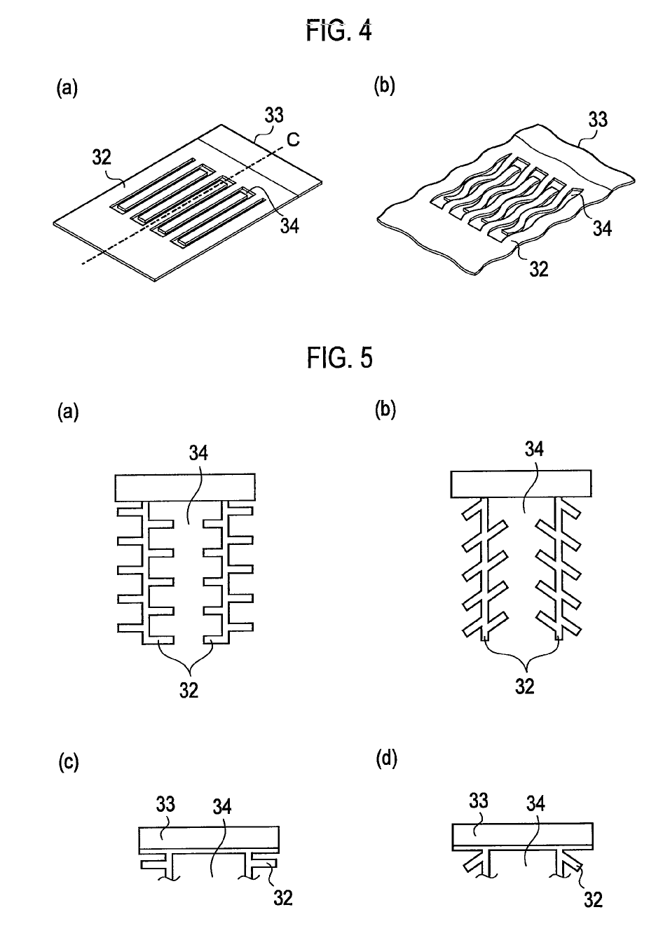

Next, description will be given of specific details of the air-supplying mechanism 3 with reference to FIG. 3. The fuel cell 100 according to the present embodiment includes a tabular vibrating plate 32. The vibrating plate 32 is disposed so as to face the oxidant electrode 12 (membrane electrode assembly 1) with a gas-flow path 30 formed between the vibrating plate 32 and the oxidant electrode 12, and generates an acoustic wave. The vibrating plate 32 is caused to vibrate by a piezoelectric element 33 (see FIG. 4).

The piezoelectric element 33A is preferably a material having a high piezoelectric constant, for example, lead zirconate titanate (PZT). Alternatively, quartz (SiO₂) or a piezoelectric ceramic such as lithium tantalate (LiTaO₃), lithium niobate (LiNbO₃) and lithium tetraborate (Li₂B₄O₇) may be used as the piezoelectric element 33.

The vibrating plate 32A is preferably a material which is light in weight and has a high Young's modulus, for example, aluminum. Alternatively, in a case of metal, duralumin, stainless steel or titanium can be used as the vibrating plate 32. In a case of ceramic, alumina, barium titanate, ferrite, silicon dioxide, zinc oxide, silicon carbide or silicon nitride can be used as the vibrating plate 32. In a case of plastic, a fluororesin, a polyphenylene sulfide resin, a polyether sulfone resin, polyimide, polyacetal, or an ethylene/vinyl alcohol copolymer (EVOH) resin can be used as the vibrating plate 32. Meanwhile, the thickness of the vibrating plate 32 is preferably 1.0 mm or smaller.

In this respect, a gas is transferred by vibration of the vibrating plate 32 or by a gas-supplying unit disposed outside. Meanwhile, water formed by the oxidant electrode 12 becomes water vapor 40 after passing through the hole 34 in the vibrating plate 32, and discharged to the outside. The distance between the vibrating plate 32 and the oxidant electrode 12 is preferably within 0.1 to 5.0 mm so that the vibrating plate 32 and the oxidant electrode 12 may come into contact with the formed water. Note that the membrane electrode assembly 1, the fuel-supplying mechanism 2 and the air-supplying mechanism 3 are disposed in a case 10.

In addition, as shown in FIG. 3, the vibrating plate 32 is formed to have at least one hole 34. Moreover, the vibrating plate 32 has a shape in which comb-shaped portions face and interdigitate with each other with the hole 34 formed between the comb-shaped portions as shown in FIG. 4(a). When the vibrating plate 32 is caused to vibrate using the piezoelectric element 33, the vibrating plate 32 vibrates as shown in FIG. 4(b).

Herein, the frequency of the vibration by the piezoelectric element 33 includes all of the ultrasonic range, audio frequency range and infrasound frequency range. The audio frequency range and the infrasound frequency range have a merit that energy loss is low in comparison with the ultrasonic range. Meanwhile, the ultrasonic range and the infrasound frequency range have a merit that they are difficult for a user to recognize as a noise in comparison with the audio frequency range.

Furthermore, the vibrating plate 32 may have a multi-branched shape as shown in FIG. 5 instead of the comb shape. FIG. 5(a) shows Modification Example 1 of the vibrating plate 32. FIG. 5(b) shows Modification Example 2 of the vibrating plate 32. Additionally, FIG. 5(c) shows the detail of the base end portion of the vibrating plate 32 shown in FIG. 5(a). FIG. 5(d) shows the detail of the base end portion of the vibrating plate 32 shown in FIG. 5(b).

Moreover, the vibrating plate 32 has a hydrophilic surface on the oxidant electrode 12 side. The oxidant electrode 12 has a water-repellent surface on the vibrating plate 32 side. The vibrating plate 32 can be surface-treated with, for example, titanium oxide or the like so that the surface can be hydrophilic. The hydrophilic coating is not limited to titanium oxide. Silicon nitride and iron oxide may be applied.

Meanwhile, the oxidant electrode 12 can be surface-treated with, for example, PTFE (polytetrafluoroethylene) or the like so that the surface can be water-repellent. The water-repellent coating is not limited to PTFE. FEP (tetrafluoroethylene-hexafluoropropylene copolymer) and PFA (tetrafluoroethylene-perfluoroalkylvinyl ether copolymer) may be applied.

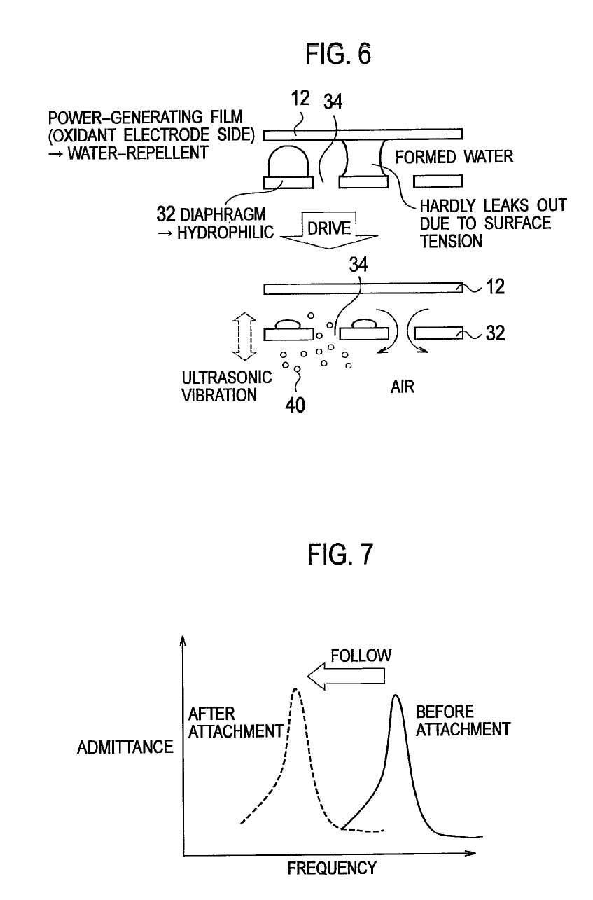

The water formed from the aforementioned water-repellent oxidant electrode 12 is attached to the hydrophilic vibrating plate 32 as shown in FIG. 6. The formed water which has moved from the oxidant electrode 12 to the vibrating plate 32 hardly leaks out due to the surface tension. Then, by causing the vibrating plate 32 to vibrate by, for example, ultrasound, the water attached to the vibrating plate 32 evaporates away with the air movement in a form of the water vapor 40.

Moreover, the fuel cell 100 may further include a control circuit 300 (see FIG. 10) which controls the vibration of the vibrating plate 32, and which provides the resonant frequency of the vibrating plate 32. Although this controlling method will be described in detail later, when formed water is attached to the vibrating plate 32, the resonant frequency of the vibrating plate 32 changes. For example, the resonant frequency of the vibrating plate 32, which is normally 60 kHz, changes to 50 kHz after the attachment.

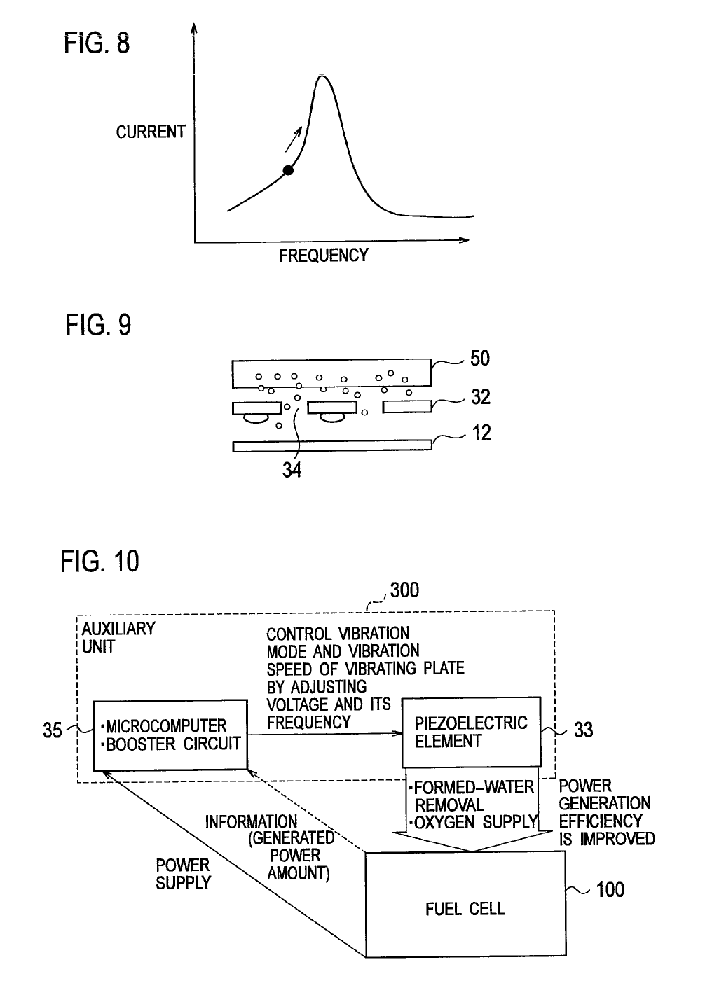

At this point, the control circuit 300 performs the controlling so as to follow the resonant frequency after the attachment as shown in FIG. 7. For example, when the piezoelectric element 33, is used as the control circuit 300, the frequency at which the input current is maximized is a resonant frequency. Accordingly, the local maximum frequency value at which the input current is maximized as shown in FIG. 8 is determined, and the obtained frequency is set as the resonant frequency. Incidentally, the piezoelectric element 33 is used as means for vibrating the vibrating plate 32 in the above description. Other than this, a magnetostrictor or the like may be used. The piezoelectric element or the magnetostrictor is desirably coated for waterproof.

Moreover, in the present embodiment, formed water may let to evaporate directly. Alternatively, an absorbent 50 that absorbs water vapor may be disposed as shown in FIG. 9, or a cold trap that collects and cools air into a liquid form may be disposed.

Additionally, when the fuel cell 100 according to the present embodiment is disposed in a cell phone or the like and generates electricity, a droplet-removing state may be informed by a display function such as sound, vibration, light, or the like so that a pocket or a bag into which the cell phone or the like is put can be prevented from getting wet.

(Controlling Method of Fuel Cell)

Next, description will be given of the controlling method of the fuel cell 100 according to the present embodiment.

FIG. 10 shows a functional block diagram of a fuel cell system according to the present embodiment. Here, as an auxiliary unit 300 for controlling the fuel cell 100, a microcomputer-booster circuit 35 and the piezoelectric element 33 are described. The auxiliary unit 300 may be incorporated into the fuel cell 100.

The microcomputer-booster circuit 35 adjusts a voltage and a frequency of the voltage to supply the piezoelectric element 33 with a control signal for controlling the vibration mode and vibration speed of the vibrating plate 32. The piezoelectric element 33 makes the vibrating plate 32, which is disposed in the fuel cell 100, vibrate to supply oxygen or remove formed water. Thus, the power generation efficiency of the fuel cell 100 can be improved.

Meanwhile, the microcomputer-booster circuit 35 may be supplied with power from the fuel cell 100 as shown in FIG. 10, or may be supplied with power from an unillustrated external power source.

Meanwhile, the fuel cell 100 may inform the microcomputer-booster circuit 35 of information on the amount of generated power. Here, when the amount of generated power is greater than a desired amount, the microcomputer-booster circuit 35 lowers the voltage to decrease the amount of oxygen to be supplied and the amount of formed water to be removed, thereby decreasing the amount of power to be generated. On the other hand, when the amount of generated power is smaller than a predetermined amount, the microcomputer-booster circuit 35 raises the voltage to increase the amount of oxygen to be supplied and the amount of formed water to be removed, thereby increasing the amount of power to be generated.

Meanwhile, the microcomputer-booster circuit 35 may adjust the distance between the oxidant electrode 12 and the vibrating plate 32 to change the amount of formed water droplets to be evaporated and the amount of air to be supplied, thus adjusting the power generation efficiency. The waveform of the voltage that the microcomputer-booster circuit 35 applies to the piezoelectric element 33 is a sine wave, square wave, triangle wave, sawtooth wave, or the like, in the ultrasonic range. When a number of resonant frequencies of the vibrating plate 32 are present, the microcomputer-booster circuit 35 may change the vibration mode through the frequency adjustment, thereby adjusting the amount of oxidants to be supplied and the amount of formed water to be evaporated. In order to reduce the power consumption, the microcomputer-booster circuit 35 may be driven intermittently for only a necessary time period.

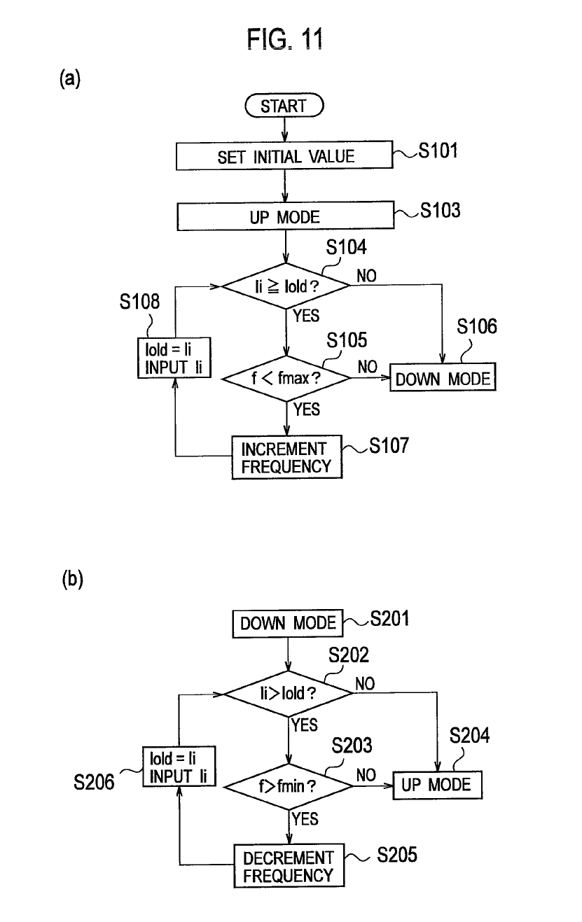

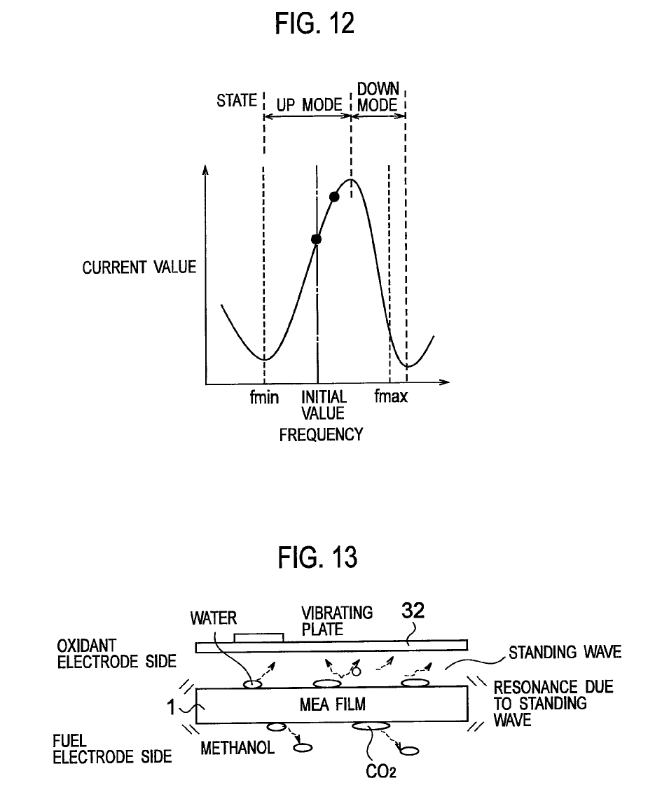

Subsequently, the controlling method of the vibrating plate 32 by the piezoelectric element 33 will be described with reference to FIG. 11 and FIG. 12. The microcomputer-booster circuit 35 that controls the piezoelectric element 33 performs the following processings.

First of all, in Step S101 of FIG. 11(a), the microcomputer-booster circuit 35 sets the initial value of the frequency. For example, the microcomputer-booster circuit 35 sets the frequency (f) to 60 kHz. Moreover, the microcomputer-booster circuit 35 measures the current value in this state, and substitutes this value for a current value (Ii) and a current value (Iold). Note that the current value (Ii) indicates a current value to be updated every time, and the current value (Iold) indicates a current value measured at a previous time. In the first measurement, the same values are saved as the current value (Ii) and the current value (Iold).

At first the microcomputer-booster circuit 35 proceeds to an UP mode in Step S103. Note that, herein, the UP mode refers to a case where the frequency is increased to a frequency greater than the frequency detected at the previous time, while a DOWN mode is defined as a mode where the frequency is decreased to a frequency smaller than the frequency detected at the previous time.

Thereafter, in Step S104, the microcomputer-booster circuit 35 judges whether or not the current value (Ii) is equal to or greater than the current value (Iold) at the previous time. When the current value (Ii) is equal to or greater than the current value (Iold) at the previous time, the microcomputer-booster circuit 35 proceeds to Step S105.

In Step S105, the microcomputer-booster circuit 35 judges whether or not the frequency (I) at this time is smaller than a maximum frequency (fmax). Herein, the maximum frequency (fmax) is a value set in advance.

When the frequency (f) at this time is smaller than the maximum frequency, the microcomputer-booster circuit 35 proceeds to Step S107, and increments the frequency. When the frequency (I) at this time is equal to or greater than the maximum frequency, the microcomputer-booster circuit 35 proceeds to Step S106, i.e., FIG. 11(b), and performs the DOWN mode processing.

In Step S107, after incrementing the frequency, the microcomputer-booster circuit 35 proceeds to Step S108. The microcomputer-booster circuit 35 substitutes the current value (Ii) at this time for the current value (Iold) at the previous time, and substitutes the current value thus incremented for the current value (Ii). Then, the microcomputer-booster circuit 35 returns to the processing in Step S104.

In the case of the DOWN mode in Step S201 of FIG. 11(b), and subsequently, in Step S202, the microcomputer-booster circuit 35 judges whether or not the current value (Ii) is greater than the current value (Iold) at the previous time. When it is greater, the microcomputer-booster circuit 35 proceeds to Step S203, and judges whether or not the frequency (i) at this time is greater than a minimum frequency (fmin). Here, the minimum frequency (fmin) is a value set in advance.

When the frequency (I) at this time is greater than the minimum frequency, the microcomputer-booster circuit 35 proceeds to Step S205, and decrements the frequency. When the frequency (f) at this time is equal to or smaller than the minimum frequency, the microcomputer-booster circuit 35 proceeds to Step S204, i.e., Step S103 of FIG. 11(a), and performs the UP mode processing.

In Step S205, after decrementing the frequency, the microcomputer-booster circuit 35 proceeds to Step S206. The microcomputer-booster circuit 35 substitutes the current value (Ii) at this time for the current value (Iold) at the previous time, and substitutes the current value after the decrement for the current value (Ii). Then, the microcomputer-booster circuit 35 returns to the processing in Step S202.

In this manner, the microcomputer-booster circuit 35 moves to either the UP mode or the DOWN mode on the basis of the frequency and the current value detected at the previous time, and repeats these processings.

(Effects and Advantages)

The fuel cell 100 according to the present embodiment provided with the vibrating plate 32 having at least one hole 34 is capable of easily removing water formed therein, sine the water evaporates through the hole 34 formed in the vibrating plate 32. Thereby, the power generation efficiency of the fuel cell 100 can be improved.

Moreover, the vibrating plate 32 has the hydrophilic surface on the oxidant electrode 12 side, and the oxidant electrode 12 has the water-repellent surface on the vibrating plate 32 side. This facilitates the movement of formed water from the oxidant electrode 12 side to the vibrating plate 32 side, and increases the contact area between the formed water and the vibrating plate 32. As a result, the energy is more easily transferred, and the formed water can be removed more efficiently.

Moreover, the vibrating plate 32 has a shape in which the comb-shaped portions face each other with the hole 34 formed between the comb-shaped portions. Thereby, the amplitude at a portion that corresponds to a loop of the vibration is increased, and the vibration energy is increased. Thus, a larger amount of formed water can be removed.

Moreover, the fuel cell 100 according to the present embodiment may further include the circuit which controls the vibration of the vibrating plate 32, and which provides the resonant frequency of the vibrating plate 32. Accordingly, even if the water droplets are attached to the vibrating plate 32 and cause the resonant frequency to change, the resonant frequency corresponding to that state can be provided.

Furthermore, in the present embodiment, the inside of the MEA film (membrane electrode assembly 1) can resonate by the driven vibration of the vibrating plate 32, as shown in FIG. 13. Accordingly, by the vibration of the MEA film, water attached to the surface of the oxidant electrode 12 in the MEA film or carbon dioxide attached to the surface on the fuel electrode of the oxidant-electrode surface film in the MEA film can diffuse into the flow path.

### Second Embodiment

In the first embodiment, the description has been given that a gas is transferred by the vibration of the vibrating plate 32 or the gas-supplying unit. In a second embodiment, description will be given of a case where a gas is transferred by acoustic streaming that occurs in the gas-flow path 30 due to vibration of the vibrating plate 32 and reflection on the surface of the oxidant electrode 12 facing the vibrating plate 32.

Now, acoustic streaming will be described. Acoustic streaming is a steady flow of a fluid and generated by a sound field.

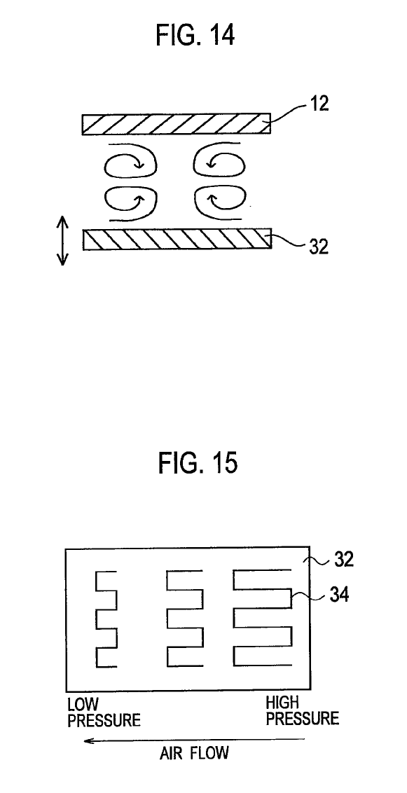

As shown in FIG. 14, the vibrating plate 32 and the reflection plate (here, the surface of the oxidant electrode 12) are disposed so as to face each other. When the vibrating plate 32 is caused to vibrate to thus generate a standing wave in the ultrasonic range, air-column resonance occurs between the vibrating plate 32 and the reflection plate. As the air-column resonance occurs, a spiral flow occurs between the vibrating plate 32 and the reflection plate. When the air-column resonance occurs, a sound pressure gradient is formed, and a fluid in the flow path flows from a higher-sound-pressure position to a lower-sound-pressure position. This flow is referred to as the acoustic streaming. The acoustic streaming thus occurred transfers a gas in the fuel cell 100.

In this manner, the gas fed to the oxidant electrode 12 is transferred by the acoustic streaming that occurs in the gas-flow path 30. Thereby, oxygen can be fed to the oxidant electrode 12 efficiently.

In the present embodiment, the sound pressure gradient is formed as follows.

As shown in FIG. 15, the vibrating plate 32 has the multiple holes 34, and has a shape in which comb-shaped portions face each other with each hole 34 formed between the comb-shaped portions. The length of respective tooth provided on each of the comb-shaped portions increases stepwise from one side of the vibrating plate 32 to the other side. The holes 34 in the vibrating plate 32 are preferably shaped symmetrically with respect to a central line C (see FIG. 4(a)) of the vibrating plate 32. Herein, the sound pressure gradient can be formed by providing the vibrating plate 32 having the comb-shape portions that the length of respective tooth provided on each of the comb-shape portions increases stepwise in a gas-flowing direction. Since the shape of the holes 34 in the vibrating plate 32 is symmetrical with respect to the central line C, the vibrating plate 32 can vibrate uniformly.

The other points are the same as those in the first embodiment.

### Third Embodiment

In a third embodiment, description will be given of a case where the vibrating plate 32 having the holes 34 and the oxidant electrode 12 are disposed in a way that the vibrating plate 32 is not parallel to the surface of the oxidant electrode 12.

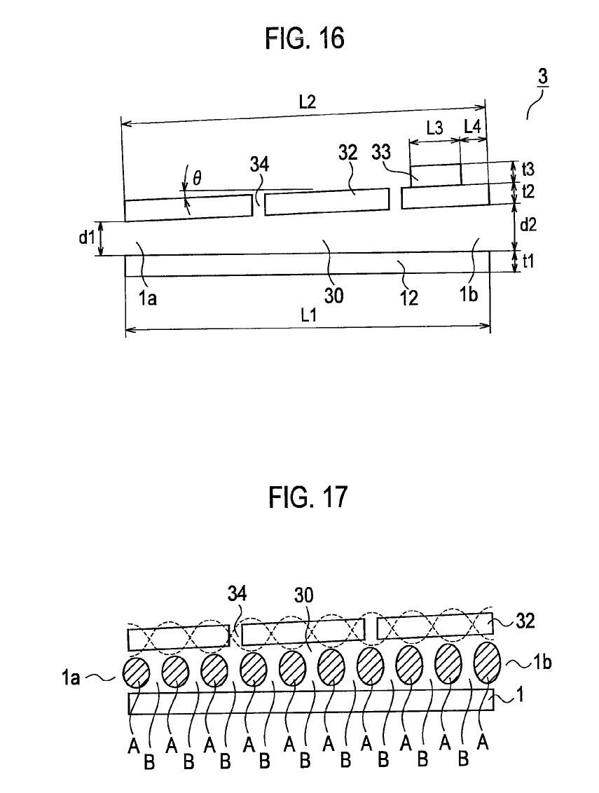

As shown in FIG. 16, the oxidant electrode 12 and the vibrating plate 32 have lengths L1, L2 of approximately 50 mm, thicknesses of t1, t2 of approximately 1 mm, respectively. Moreover, the vibrating plate 32 is disposed so that the space between the vibrating plate 32 and the oxidant electrode 12 (hereinafter, referred to as a height of the flow path 30) can gradually increase in a direction of the length LI. The vibrating plate 32 is disposed to incline only by an angle θ of approximately 2° so that a space dl on an air inlet 1a side can be approximately 2 mm, and that a space d2 on an air outlet 1b side can be approximately 4 mm.

Moreover, the piezoelectric element 33 has a strip shape with a length L3 of approximately 3 mm, and a width W2 of approximately 30 mm and a thickness t3 of approximately 1 mm. The piezoelectric element 33 is formed on the vibrating plate 32 and apart from the edge portion on the air outlet 1b side of the vibrating plate 32 by a distance L4 of approximately 7 mm.

In the fuel cell 100 according to the third embodiment, firstly, an alternating voltage of approximately 70 kHz is applied to the piezoelectric element 33 by using an alternating-current power source (unillustrated). Thereby, the piezoelectric element 33 expands or contracts in a direction of the length L3 to drive the vibration of the vibrating plate 32. Accordingly, an acoustic wave is generated by the vibrating plate 32. The acoustic wave thus generated is reflected multiple times in the flow path 30 between the oxidant electrode 12 and the vibrating plate 32, thereby increasing the sound pressure within the flow path 30.

As a result, acoustic streaming occurs in the flow path 30, generating a force for moving air in the flow path 30. Here, the flow path 30 is formed so that the height on the air inlet 1b side is higher than that on the air outlet 1a side. Thus, the pressure loss is smaller in a case where the air in the flow path 30 moves toward the air outlet 1b than in a case where the air moves toward the air inlet 1a. Thereby, the air is discharged from the air outlet 1b side where the height of the flow path 30 is high, and air is supplied into the flow path 30 from the air inlet 1a where the height of the flow path 30 is low.

Moreover, as shown in FIG. 17, the acoustic wave generated by the vibrating plate 32 is reflected multiple times in the flow path 30 between the oxidant electrode 12 and the vibrating plate 32. Thus, when the height of the flow path 30 and the wavelength of the acoustic wave satisfy the resonance conditions, the acoustic wave can resonate.

Under a condition that the height of the flow path 30 increases in the direction of the length L1, the acoustic wave presumably resonates in the flow path 30 on the air inlet 1a side where the height of the flow path 30 is approximately 3 mm. In this case, a standing wave of the acoustic wave is generated in a region of the flow path 30 on the air inlet 1a side described above. The standing wave of the acoustic wave further increases the sound pressure in the flow path 30 on the air inlet 1a side. As a result, air can be further efficiently transferred from the air inlet 1a toward the air outlet lb along the flow path 30.

The other points are the same as those in the first embodiment.

### Fourth Embodiment

In a fourth embodiment, description will be given of a case where the thickness of the vibrating plate 32 having the holes 34 changes in a direction of the flow path.

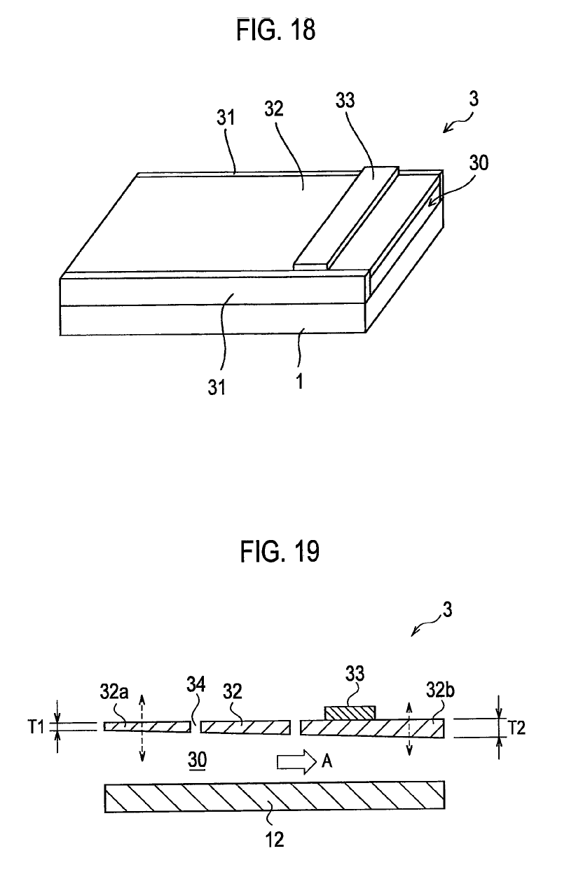

In the fuel cell 100 according to the fourth embodiment, as shown in FIG. 18, a pair of flow path walls 31 are respectively provided on both sides of the flow path 30. The flow path walls 31 are upright on the surface of the membrane electrode assembly 1 while extending along the flow path 30. The vibrating plate 32 covering the flow path 30 is provided so as to extend over the two flow path walls 31. The piezoelectric element 33 is provided on the upper surface of the vibrating plate 32.

As shown in FIG. 19, the vibrating plate 32 and the surface of the membrane electrode assembly 1 face each other with a space formed between the vibrating plate 32 and the surface. An acoustic wave generated by vibration of the vibrating plate 32 is reflected in the flow path 30 between the surface of the membrane electrode assembly 1 and the vibrating plate 32.

Here, the vibrating plate 32 has a minimum thickness T1 at an edge portion 32a on an inlet side of the flow path 30 (edge portion on the left side of FIG. 19) and a maximum thickness T2 at an edge portion 32b on an outlet side of the flow path 30 (edge portion on the right side of FIG. 19). In other words, the cross section of the vibrating plate 32 is wedge shaped.

In the air-supplying mechanism 3, the space between the vibrating plate 32 and the surface of the membrane electrode assembly 1 is designed to have a resonance height (for example, 0.1 to 5 mm) so that air-column resonance can occur. The piezoelectric element 33 makes the vibrating plate 32 generate a standing wave in the ultrasonic range. Thereby, air-column resonance is generated between the vibrating plate 32 and the surface of the membrane electrode assembly 1.

Here, the vibrating plate 32 has a low flexural rigidity on the inlet side of the flow path 30, since the thickness at this part is small; meanwhile, the vibrating plate 32 has a high flexural rigidity on the outlet side, since the thickness at this part is large. For this reason, the vibrating plate 32 vibrates with a large amplitude on the inlet side of the flow path 30, and vibrates with a small amplitude on the outlet side of the flow path 30, as shown in dotted arrows in FIG. 19. Thereby, the sound pressure in the flow path 30 is high on the inlet side and low on the outlet side.

A sound pressure gradient is formed from the inlet to the outlet of the flow path 30 in a descending manner. The sound pressure gradient thus formed causes acoustic streaming to occur from the inlet toward the outlet in the flow path 30. Thus, air in the flow path 30 uniformly flows from the inlet toward the outlet.

As a result, air is supplied to the membrane electrode assembly 1, and the power-generating reaction takes place in the membrane electrode assembly 1.

The other points are the same as those in the first embodiment.

### Fifth Embodiment

In a fifth embodiment, description will be given of a case where the vibrating plate 32 having the holes 34 is formed to extend beyond the flow path 30.

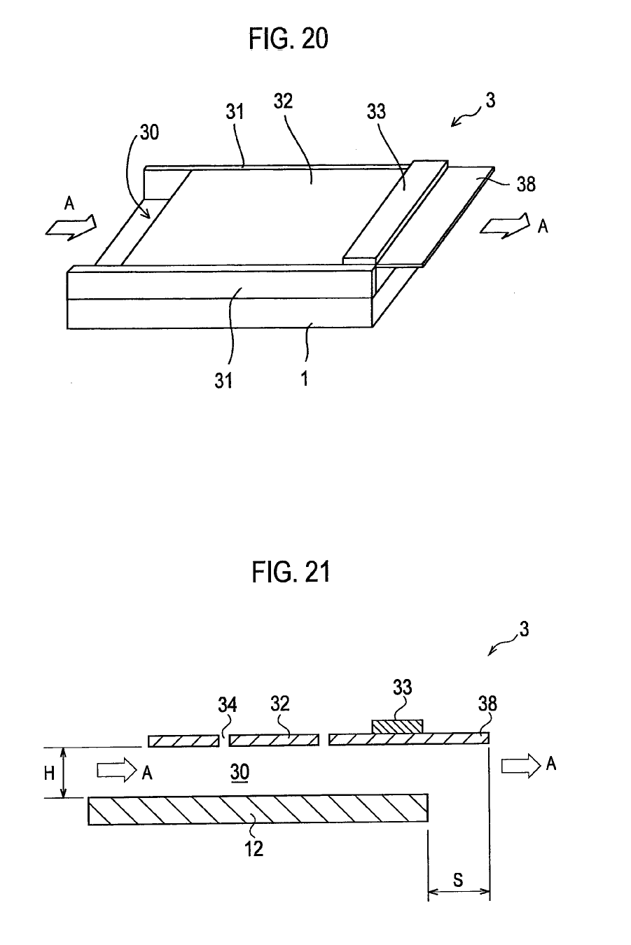

In the fuel cell 100 according to the fifth embodiment, as shown in FIG. 20, a pair of flow path walls 31 are respectively provided on both sides of the flow path 30. The flow path walls 31 are upright on the surface of the membrane electrode assembly 1 while extending along the flow path 30. The vibrating plate 32 covering the flow path 30 is provided so as to extend over the two flow path walls 31. The piezoelectric element 33 is provided on the upper surface of the vibrating plate 32.

Thereby, the vibrating plate 32 and the surface of the membrane electrode assembly 1 face each other with a predetermined space H formed between the vibrating plate 32 and the surface as shown in FIG. 21. An acoustic wave generated by vibration of the vibrating plate 32 is reflected in the flow path 30 between the surface of the membrane electrode assembly 1 and the vibrating plate 32.

Here, the vibrating plate 32 includes a region 38 on an outlet side (right side of FIG. 21) of the flow path 30. The region 38 extends outward (rightward in FIG. 21) of the membrane electrode assembly 1 only by a predetermined distance S, and accordingly does not face the surface of the membrane electrode assembly 1.

In the air-supplying mechanism 3, the space H between the vibrating plate 32 and the surface of the membrane electrode assembly 1 is designed to have a resonance height (for example, 0.1 to 5 mm) so that air-column resonance can occur. The piezoelectric element 33 makes the vibrating plate 32 generate a standing wave in the ultrasonic range. Thereby, air-column resonance is generated between the vibrating plate 32 and the surface of the membrane electrode assembly 1.

Moreover, the extending distance S of the region 38 at the edge portion of the vibrating plate 32 is designed to be an appropriate distance (for example, 0.5 to 5 mm) approximately half of the wavelength of the standing wave generated by the vibrating plate 32, for example. Accordingly, a sound pressure gradient is formed from an inlet toward the outlet of the flow path 30 in a descending manner. Thereby, acoustic streaming occurs from the inlet toward the outlet in the flow path 30, and air in the flow path 30 uniformly flows from the inlet toward the outlet as shown by arrows A.

As a result, air is supplied to the membrane electrode assembly 1, and the power-generating reaction takes place in the membrane electrode assembly 1.

The other points are the same as those in the first embodiment.

### Other Embodiments

The present invention has been described on the basis of the aforementioned embodiments. However, the description and the drawings constituting parts of this disclosure are not construed to limit the invention. Various alternative embodiments, examples, and operation technologies will be obvious to those skilled in the art from this disclosure.

For example, in the present embodiment, the shape of the hole 34 has been described. Besides, the shape of the hole 34 may be circular, for example.

Hence, it goes without saying that the present invention includes various embodiments and the like not described herein. The technical scope of the present invention, thus, should only be defined by the claimed elements according to the scope of claims reasonably understood from the above description.

Note that the entire contents of Japanese Patent Application Nos. 2006-270097 (filed on Sep. 29, 2006) and 2007-234622 (filed on Sep. 10, 2007) are incorporated herein by reference.

### INDUSTRIAL APPLICABILITY

A fuel cell according to the present invention is capable of easily removing water formed therein. Therefore, the present invention is useful in a fuel cell including a membrane electrode assembly in which an oxidant electrode and a fuel electrode are disposed on the respective sides of an electrolyte layer.

1. A fuel cell including a membrane electrode assembly in which an oxidant electrode and a fuel electrode are disposed respectively on sides of an electrolyte layer, the fuel cell comprising:
a vibrating plate disposed so as to face the oxidant electrode with a flow path for a gas formed between the vibrating plate and the oxidant electrode, and configured to vibrate, wherein
the vibrating plate is formed to have at least one hole,
the vibrating plate has a hydrophilic surface on the oxidant electrode side, and
the oxidant electrode has a water-repellent surface on the vibrating plate side.

2. (canceled)

3. The fuel cell according to claim 1, wherein the vibrating plate has a shape in which comb-shaped portions face each other with the hole formed between the comb-shaped portions.

4. The fuel cell according to claim 1, wherein the gas is transferred by acoustic streaming that occurs in the flow path for the gas due to the vibration of the vibrating plate and reflection on a surface of the oxidant electrode facing the vibrating plate.

5. The fuel cell according to claim 4, wherein the hole in the vibrating plate is shaped symmetrically with respect to a central line of the vibrating plate.

6. The fuel cell according to claim 4, wherein
the vibrating plate has a plurality of holes, and has a shape in which comb-shaped portions face and interdigitate with each other with each of the plurality of holes formed between the comb-shaped portions, and
length of respective tooth provided on each of the comb-shaped portions increases stepwise from one side of the vibrating plate toward the other side.

7. The fuel cell according to claim 1, further comprising:
a circuit configured to control the vibration of the vibrating plate and to provide a resonant frequency of the vibrating plate.

8. A fuel cell including a membrane electrode assembly in which an oxidant electrode and a fuel electrode are disposed respectively on sides of an electrolyte layer, the fuel cell comprising:
a vibrating plate disposed so as to face the oxidant electrode with a flow path for a gas formed between the vibrating plate and the oxidant electrode, and configured to vibrate, wherein
the vibrating plate is formed to have at least one hole, and
the vibrating plate has a shape in which comb-shaped portions face each other with the hole formed between the comb-shaped portions.

9. A fuel cell including a membrane electrode assembly in which an oxidant electrode and a fuel electrode are disposed respectively on sides of an electrolyte layer, the fuel cell comprising:
a vibrating plate disposed so as to face the oxidant electrode with a flow path for a gas formed between the vibrating plate and the oxidant electrode, and configured to vibrate, wherein
the vibrating plate is formed to have at least one hole,
the gas is transferred by acoustic streaming that occurs in the flow path for the gas due to the vibration of the vibrating plate and reflection on a surface of the oxidant electrode facing the vibrating plate,
the vibrating plate has a plurality of holes, and has a shape in which comb-shaped portions face and interdigitate with each other with each of the plurality of holes formed between the comb-shaped portions, and
length of respective tooth provided on each of the comb-shaped portions increases stepwise from one side of the vibrating plate toward the other side.
